(19) United States
(12) Patent Application Publication
(10) Pub. No.: US 2011/0292309 A1
(43) Pub. Date: Dec. 1, 2011

(54) STEREOSCOPIC IMAGE DISPLAYING METHOD AND STEREOSCOPIC DISPLAY DEVICE

(76) Inventors: Hsiang-Tan Lin, Keelung City (TW); Kuang-Lang Chen, Taoyuan County (TW); Chun-Chieh Chiu, Taoyuan County (TW); Shih-Chieh Lin, Taipei County (TW); Tzu-Chiang Shen, Taoyuan County (TW)

(21) Appl. No.: 12/871,938

(22) Filed: Aug. 31, 2010

(30) Foreign Application Priority Data
May 31, 2010 (TW) 099117494

(51) Int. Cl. G02B 27/22; G02F 1/13357

(52) U.S. Cl. 349/15; 359/464

(57) ABSTRACT

A stereoscopic image displaying method includes providing a left eye information during a left eye displaying time; providing a first vertical blanking interval (VBI) and opening a left eye shutter of a shutter glasses; providing a right eye information during a right eye displaying time; providing a second VBI and opening a right eye shutter of the shutter glasses; and increasing a backlight brightness respectively when the left eye shutter is opened and when the right eye shutter is opened, or respectively during the first VBI and second VBI, and reducing the backlight brightness during closing the left eye shutter and the right eye shutter, or during the left eye display time and the right eye displaying time.

### BACKGROUND OF THE INVENTION

1. Field of the Invention

The present invention is related to a stereoscopic image displaying method and a stereoscopic display device, and more particularly, to a stereoscopic image displaying method and stereoscopic display device employing shutter glasses.

2. Description of the Prior Art

Stereoscopic display technique is to provide two separate images individually to the left and right eyes of an observer. When the brain of the observer overlaps and analyzes those separate images, different depths and gradations of each component are perceived, and thus the observer obtains a stereoscopic vision.

For example, a shutter glasses type stereoscopic display device utilizes the shutter glasses providing separation by multiplexing the left shutter and the right shutter in time while the display panel provides images intend for different visual fields in time sequential manner: the display panel provides the left eye image intend for being viewed by the left eye and the right eye image intend for being viewed by the right eye alternately by scanning. And there is a pause in transmission called vertical blanking interval (VBI) existing in a period after scanning the left eye image and before scanning the right eye image; in the same concept, the VBI also exists in a period after scanning the right eye image and before scanning the left eye image. In order to provide the objective images to the objective eye but to shield the non-objective images from the non-objective eye, a left eye shutter of the eye shutter glasses is opened and a right eye shutter is closed according to the image displayed in the display panel. Or, alternatively, the left eye shutter is closed and the right eye shutter is opened according to the image displayed in the display panel. By providing different left or right eye image in time sequential manner, the observer obtains the stereoscopic vision.

In nowadays, the mainstream flat display device is the liquid crystal display (LCD) device, and it is always found that when the left eye image scanning is completed and the right eye image scanning is started, the complete left eye image is remained in the VBI due to the slow response of the pixel in the LCD. The left eye image even is remained in the right eye image when it starts scanning the right eye image, thus the right eye undesirably receives at least a portion of the left eye image that not intended for. In the same concept, the right eye image is remained in the left eye image when it starts scanning the left eye image, thus the left eye undesirably receives at least a portion of the right eye image that not intended for. Such adverse viewing experience is named “ghost image”.

Furthermore, it is well-known that an LCD device is a non-self-luminant display device, therefore a backlight module is always needed for providing backlight. However, the conventional backlight module is always in on-state even in the VBI. Accordingly, the prior art stereoscopic display device suffers high power consumption.

### SUMMARY OF THE INVENTION

Therefore the present invention provides a stereoscopic display device that is able to prevent ghost image and economize power consumption.

According to a first aspect of the present invention, there is provided a stereoscopic display device comprising a liquid crystal display (LCD) panel for alternately providing a first display information, a second display information and a vertical blanking interval (VBI) between the first display information and the second display information; a backlight module; and a backlight control unit electrically connected to the backlight module for controlling a backlight brightness of the backlight module; wherein the backlight control unit increases the backlight brightness of the backlight module when the LCD panel providing the VBI and reduces the backlight brightness of the backlight module respectively when the LCD panel providing the first display information or the second display information.

According to a second aspect of the present invention, there is provided a stereoscopic display device comprising an LCD panel alternately providing a left eye information and a right eye information by scanning; a backlight module; a shutter glasses having a left eye shutter and a right eye shutter; and a backlight control unit electrically connected to the backlight module for controlling a backlight brightness of the backlight module; wherein the backlight control unit increases the backlight brightness of backlight module respectively when the left eye shutter is opened or when the right eye shutter is opened.

According to a third aspect of the present invention, there is provided a stereoscopic image displaying method comprising providing a display panel and a backlight module, providing a first display time and displaying a first display information during the first display time, providing a second display time and displaying a second display information during the second display time, providing a VBI between the first display time and the second display time, and increasing a backlight brightness of the backlight module during the VBI and reducing the backlight brightness during the first display time and the second display time.

According to a fourth aspect of the present invention, there is provided a stereoscopic image displaying method comprising providing a display panel, a backlight module, and a shutter glasses having a left eye shutter and a right eye shutter, providing a left eye display time and displaying a left eye information in the display panel during the left eye display time, providing a first VBI and opening the left eye shutter of the shutter glasses, providing a right eye display time and displaying a right eye information in the display panel during the right eye displaying time, providing a second VBI and opening the right eye shutter of the shutter glasses, and increasing a backlight brightness of the backlight module respectively when the left eye shutter is opened or when the right eye shutter is opened, and reducing the backlight brightness when both of the left eye shutter and the right eye shutter are closed.

According to a fifth aspect of the present invention, there is provided a stereoscopic image displaying method comprising providing a first display time and a second display time alternately, and displaying a first display information and a second display information respectively during the first display time and the second display time, providing a VBI between the first display time and the second display time, increasing a backlight brightness at least during the VBI and reducing the backlight brightness at least during a portion of the first display time and in a portion of the second display time, and providing a left eye shutter opening time and a right eye shutter opening time alternately for respectively opening a left eye shutter and a right eye shutter of a shutter glasses, the left eye shutter opening time and the right eye shutter opening time respectively being equal to or longer than a period of increasing the backlight brightness.

According to the stereoscopic display device and a stereoscopic image displaying method provided by the present invention, a backlight brightness is increased during the VBI or when the left/right eye shutter is opened, and the backlight brightness is reduced when the left/right eye information is scanned or when the left/right eye shutter is closed. In other words, the switch between open-state and close-state of the shutter glasses and the brightness of the backlight module are correspondingly controlled by the provided stereoscopic display device. Consequently, the ghost image is prevented and the power consumption of the backlight module is economized.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic drawing illustrating a stereoscopic display device provided by a first preferred embodiment of the present invention.

FIGS. 2-3 are schematic drawings illustrating a stereoscopic image displaying method provided by the first preferred embodiment, wherein FIG. 3 is a diagram of a time sequence in accordance with the first preferred embodiment.

FIGS. 4-5 are diagrams of time sequences in accordance with a modification of the first preferred embodiment.

FIG. 6 is a schematic drawing illustrating a stereoscopic display device provided by a second preferred embodiment of the present invention.

FIGS. 7-8 are schematic drawings illustrating a stereoscopic image displaying method provided by the second preferred embodiment, wherein FIG. 7 is a diagram of a time sequence in accordance with the second preferred embodiment.

FIG. 9 is a diagram of a time sequence in accordance with a modification of the second preferred embodiment.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

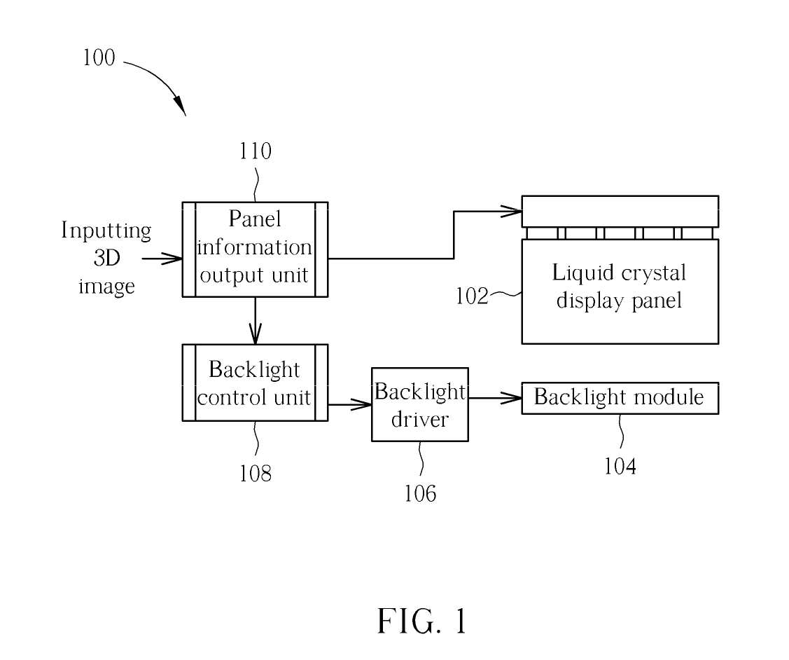

Please refer to FIG. 1, which is a schematic drawing illustrating a stereoscopic display device provided by a first preferred embodiment of the present invention. As shown in FIG. 1, a stereoscopic display device 100 including a liquid crystal display (LCD) panel 102, a backlight module 104, a backlight driver 106, a backlight control unit 108 and a panel information output unit 110 is provided. The LCD panel 102 sequentially and alternately provides a first display information Info 1 and a second display information Info 2 by scanning. The LCD panel 102 also provides a vertical blanking interval (VBI) between the first display information Info 1 and the second display information Info 2. The backlight control unit 108 is electrically connected to the backlight driver 106 and to the backlight module 104 for controlling a backlight brightness of the backlight module 104. The panel information output unit 110 is electrically connected to the LCD panel 102 and the backlight control unit 108. When an inputted image is a 3D image, the panel information output unit 110 provides the first display information Info 1 and the second display information Info 2 alternately to the LCD panel 102. It is noteworthy that the panel information output unit 110 simultaneously provides the first display information Info 1 and the second display information Info 2 to the backlight control unit 108, thus the backlight control unit 108 controls the backlight brightness in accordance with the first display information Info 1 and the second display information Info 2. For example, when the LCD panel 102 provides the VBI, the backlight control unit 108 increases the backlight brightness of the backlight module 104. When the LCD panel 102 sequentially provides the first display information Info 1 and the second display information Info 2, the backlight control unit 108 reduces the backlight brightness.

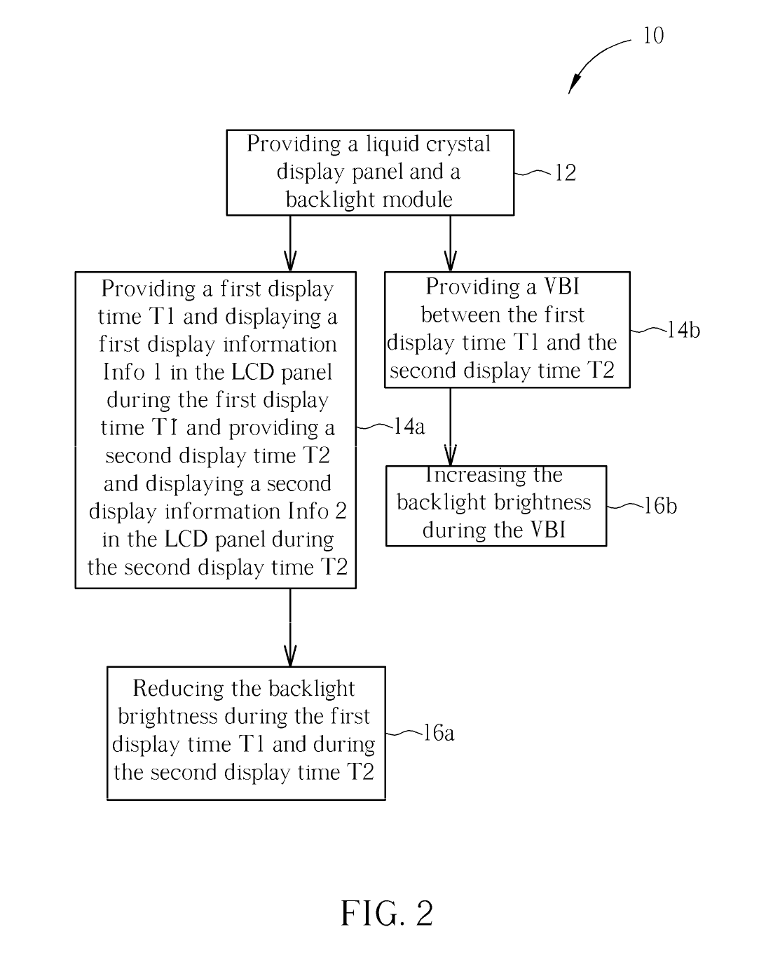

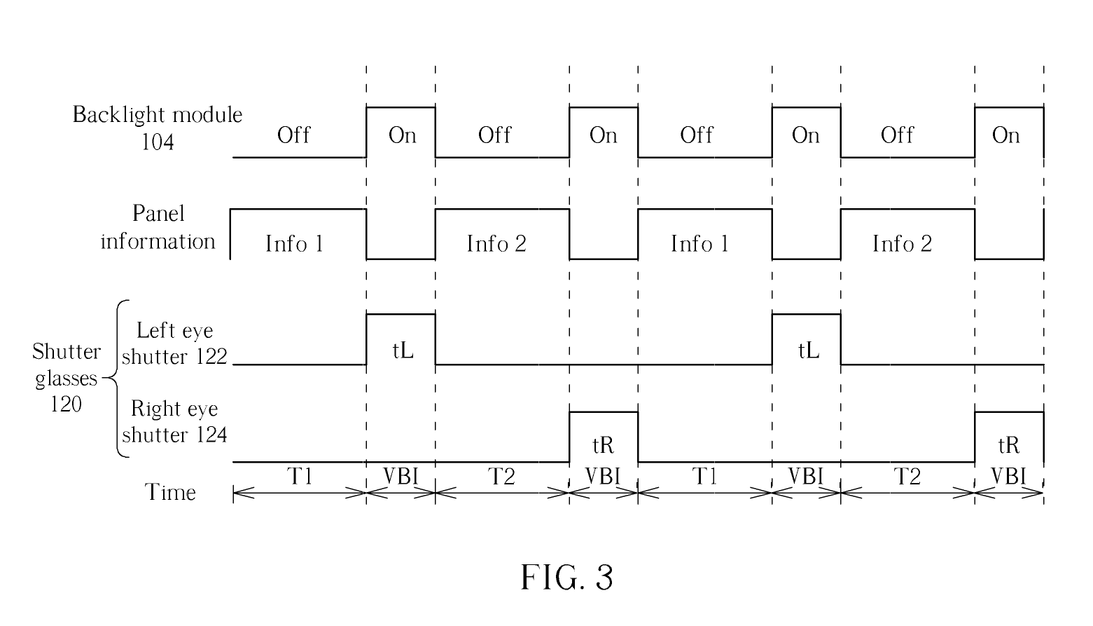

Please refer to FIGS. 2-3 which are schematic drawings illustrating a stereoscopic image displaying method provided by the first preferred embodiment, wherein FIG. 3 is a diagram of a time sequence in accordance with the first preferred embodiment. As shown in FIG. 2, in the stereoscopic image displaying method 10 provided by the first preferred embodiment, Step 12 is first performed:

Step 12: providing the liquid crystal display panel 102 and the backlight module 104;

It is noteworthy that although only the LCD panel 102 and the backlight module 104 are mentioned in Step 12, it should be understood that the stereoscopic display device 100 of the first preferred embodiment still includes the backlight module driver 106, the backlight control unit 108, and the panel information output unit 110. Since the 3D images and differences of the brightness are perceived by viewing the LCD panel 102 and the backlight module 104, only the LCD panel 102 and the backlight module 104 are emphasized in Step 12 of the stereoscopic image displaying method 10. However those skilled in the art would easily realize the structural relationship between the LCD panel 102, the backlight module 104, the backlight driver 106, the backlight control unit 108 and the panel information output unit 110 based on the abovementioned description and drawing. Therefore those details are omitted in the interest of brevity. Then, Step 14a and Step 14b are performed:

Step 14a: providing a first display time T1 and displaying a first display information Info 1 in the LCD panel 102 during the first display time T1; and providing a second display time T2 and displaying a second display information Info 2 in the LCD panel 102 during the second display time T2;

Step 14b: providing a vertical blanking interval (VBI) between the first display time T1 and the second display time T2;

Please refer to FIG. 3. When the image intended for being displayed is a 3D image, the panel information output unit 110 provides the first display information Info 1 and the second display information Info 2 to the LCD panel 102, and the LCD panel 102 sequentially and alternately provides the first display time T1 and the second display time T2 for respectively scanning and displaying the first display information Info 1 and the second display information Info 2. Additionally, it is well-known to those skilled in the art that the complete first display information Info 1 is remained in the VBI between the first display time T1 and the second display time T2. When the second display time T2 starts, the second display information Info 2 is scanned in the LCD panel 102 and gradually covers the first display information Info 1. Therefore a portion of the first display information Info 1 is remained in the second display time T2. The first display information Info 1 is completely covered by the second display information Info 2 at the end of the second display time T2, therefore the complete second display information Info 2 is remained in the VBI between the second display time T2 and the first display time T1. Thereafter, the first display time T1 is started again, and the first display information Info 1 is scanned again. The above-mentioned process can be repeated until the observer turns off the stereoscopic display device 100 or ends the stereoscopic image displaying method 10. It is noteworthy that during performing Step 14a and Step 14b, the following Step 16a and Step 16b are simultaneously performed:

Step 16a: reducing the backlight brightness during the first display time T1 and during the second display time T2;

Step 16b: increasing the backlight brightness during the VBI.

Please still refer to FIG. 3. According to the stereoscopic image displaying method 10, the panel information output unit 110 simultaneously provides the first display information Info 1 and the second display information Info 2 to the backlight control unit 108. Accordingly, the backlight control unit 108 increases the backlight brightness of the backlight module 104 during the VBI and reduces the backlight brightness of the backlight module 104 respectively during the first display time T1 and in the second display time T2. Furthermore, the “ON” designated in FIG. 3 states increasing the backlight brightness and the “OFF” states reducing the backlight brightness.

Please still refer to FIG. 3. The first preferred embodiment further provides a shutter glasses 120 having a left eye shutter 122 and a right eye shutter 124. The first preferred embodiment also provides a left eye shutter opening time tL and a right eye shutter opening time tR. The left eye shutter 122 of the shutter glasses 120 is opened during the left eye shutter opening time tL while the right eye shutter 124 is opened during the right eye shutter opening time tR. As mentioned above, since the complete first display information Info 1 and the second display information Info 2 are respectively remained in the VBI, the left eye shutter opening time tL and the right eye shutter opening time tR are respectively corresponding to the VBI for viewing the first and second information Info 1/infor 2. In detail, the left eye shutter opening time tL is corresponding to and at least entirely covers the VBI after the first display time T1, and the right eye shutter opening time tR is corresponding to and at least entirely covers the VBI after the second display time T2. Accordingly, the observer perceives a complete and non-interfered left eye image when the left eye shutter 122 is opened. In the same concept, the observer perceives a complete and non-interfered right eye image when the right eye shutter 124 is opened.

More important, since the backlight brightness of the backlight module 104 is increased during the VBI, the observer will observe an improved 3D image both in the left eye shutter opening time tL and the right eye shutter opening time tR. On the other hand, the left eye shutter 122 and right eye shutter 124 of the shutter glasses 120 are both closed during the first display time T1 and the second display time T2, therefore no images are provided the observer. Accordingly, the performance quality are not impacted by reducing the backlight brightness since the left eye shutter 122 and right eye shutter 124 are both closed during the first display time T1 and the second display time T2. In other words, by increasing the backlight brightness during the VBI, or reducing the backlight brightness during the first display time T1 and the second display time T2, the power consumption is economized while performance quality is not impacted at all.

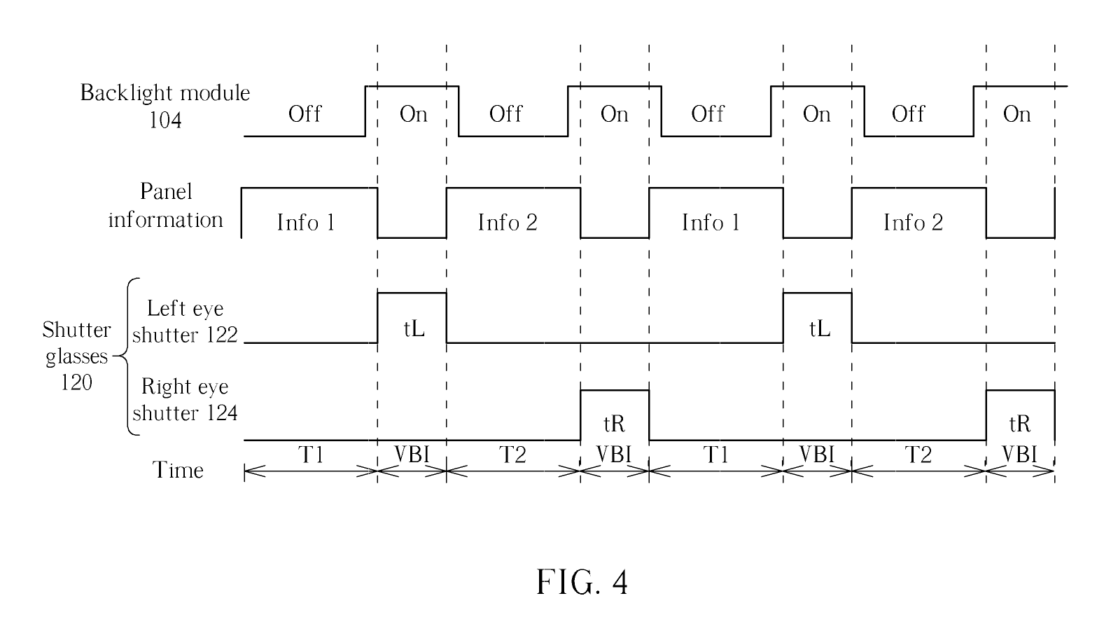

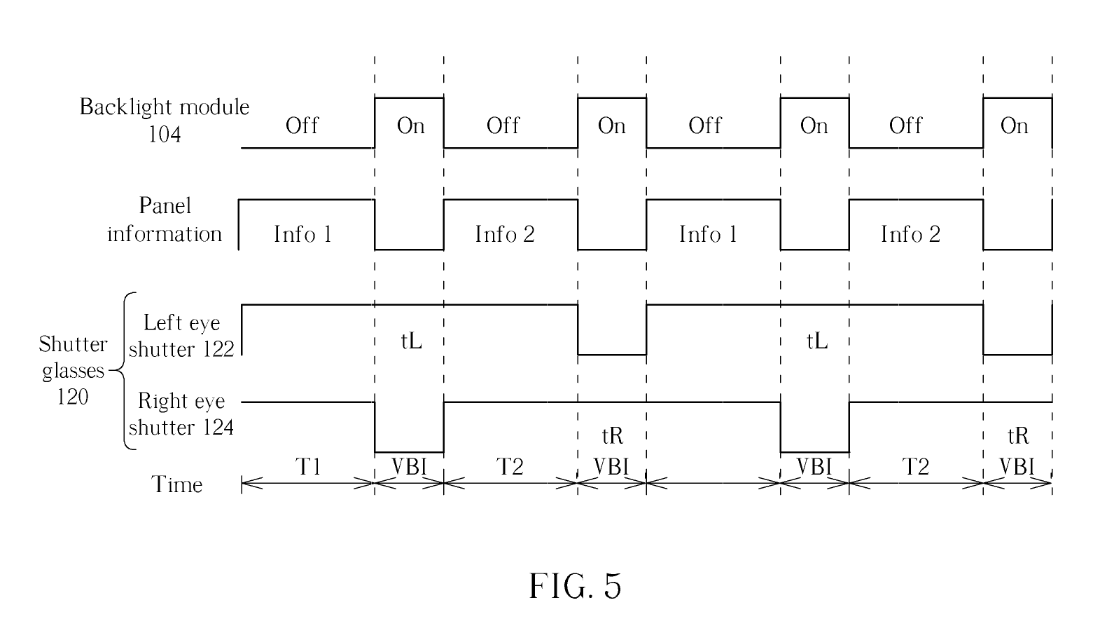

Please refer to FIGS. 4-5 which are diagrams of time sequences in accordance with a modification of the first preferred embodiment. According to the modification, the backlight control unit 108 controls the backlight brightness of the backlight module 104 in accordance with the first display information Info 1 and the second display information Info 2 provided by the panel information output unit 110. As shown in FIG. 4, a period of increasing the backlight brightness is not only corresponding to and at least entirely covers the VBI, but also longer than the VBI, therefore it can be ensured that the observer will obtain a complete, non-interfered and flicker-free 3D images when the left eye shutter 122 or the right eye shutter 124 is opened.

Please refer to FIG. 3 again. Since the left eye shutter opening time tL and the right eye shutter opening time tR are sequentially provided in accordance with the left eye image and the right eye image, substantially a half of lights are blocked from being viewed by both eyes of the observer, compared to the lights viewed from a 2D display or viewed without the shutter glasses 120. Furthermore, because the left eye shutter opening time tL and the right eye shutter opening time tR are completely corresponding and equal to the VBI in the first preferred embodiment, the period of opening the left/right eye shutter is even shorter while the period of closing the left/right eye shutter is longer. Consequently, more lights, substantially five-sixth of the lights are blocked from being viewed. Thus the observer will perceive a perceptibly darker viewing field. To overcome this problem, the left eye shutter opening time tL and the right eye shutter opening time tR are corresponding to and longer than the VBI as shown in FIG. 5: the left eye shutter opening time tL of the shutter glasses 120 starts simultaneously with the start of the first display time T1 and ends simultaneously with the end of the second display time T2 while the right eye shutter opening time tR starts simultaneously with the start of the second display time T2 and ends simultaneously with the end of the first display time T1. Since the left eye shutter opening time tL and the right eye shutter opening time tR are prolonged, the environmental lights are allowed to enter the eyes of the observer and serve as the backlight source. Consequently, the differences of the backlight brightness will not be observed. Moreover, the observer will obtain a brighter viewing experience.

As mentioned above, according to the stereoscopic display device 100 and the stereoscopic image displaying method 10 provided by the first preferred embodiment, when the inputted information is recognized as a 3D image information, the backlight control unit 108 is to control the backlight brightness of the backlight module 104: the backlight brightness is increased during the VBI while the backlight brightness is reduced during the first display time T1 and the second display time T2. Accordingly, the performance quality of the 3D image is improved and the power consumption is simultaneously economized.

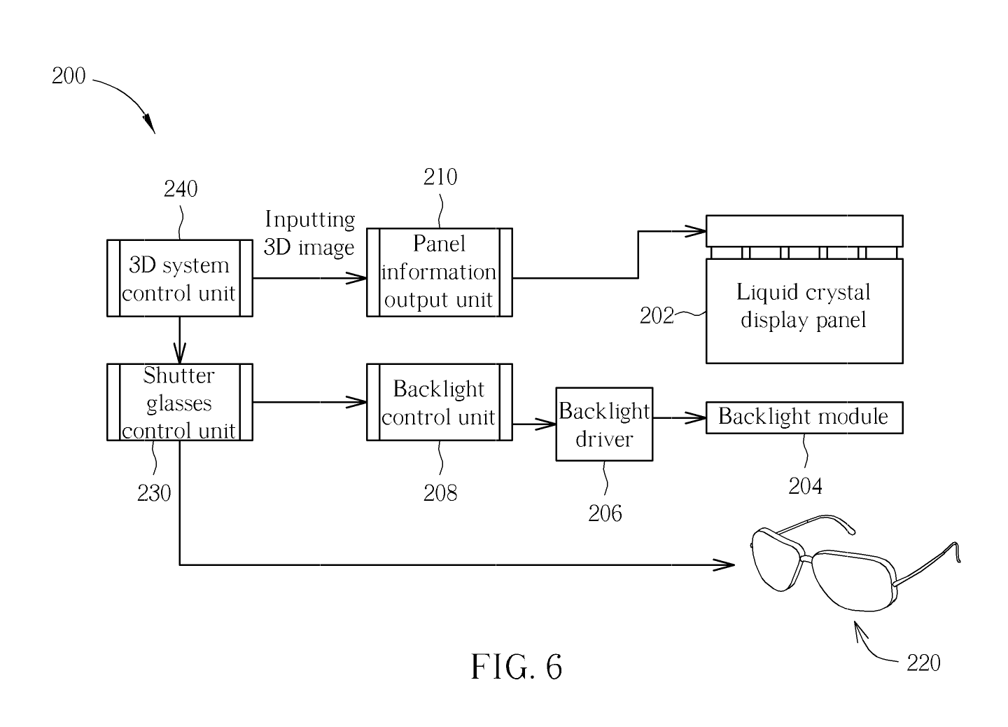

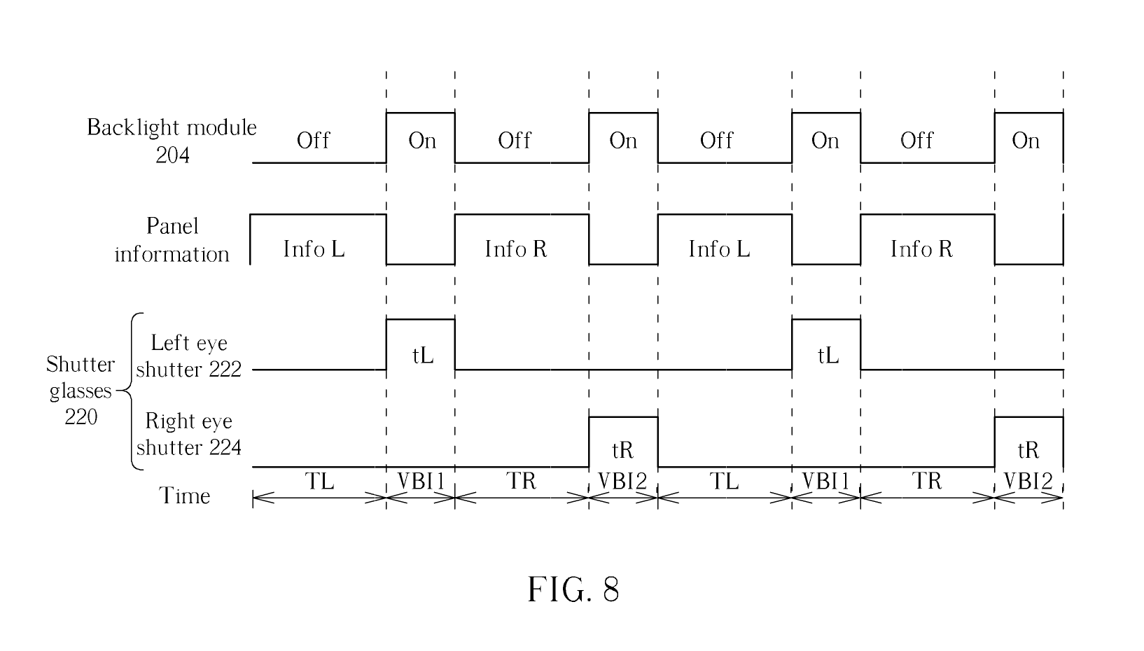

Please refer to FIG. 6, which is a schematic drawing illustrating a stereoscopic display device provided by a second preferred embodiment of the present invention. As shown in FIG. 6, a stereoscopic display device 200 including an LCD panel 202, a backlight module 204, a backlight driver 206, a backlight control unit 208, a panel information output unit 210, a shutter glasses 220, a shutter glasses control unit 230 and a 3D system control unit 240 is provided. The 3D system control unit 240 is electrically connected to the panel information output unit 210 and the shutter glasses control unit 230. When the image intended for displaying is recognized as a 3D image, the 3D system control unit 240 inputs an left eye information Info L and a right eye information Info R to the panel information output unit 210 and simultaneously to the shutter glasses control unit 230. The panel information output unit 210 is electrically connected to the LCD panel 202 and subsequently provides the left eye information Info L and the right eye information Info R to the LCD panel 202. And the LCD panel 202 sequentially and alternately provides the left eye information Info L and the right eye information Info R by scanning. The shutter glasses control unit 230 is electrically connected to the backlight control unit 208 and the shutter glasses 220 having a left eye shutter 222 and a right eye shutter 224 (shown in FIG. 8). When the 3D system control unit 240 provides the left eye information Info L and the right eye information Info R to the shutter glasses control unit 230, the shutter glasses control unit 230 provides open/close signals to the shutter glasses 220 and simultaneously to the backlight control unit 208 in accordance with the left eye information Info L and the right eye information Info R. The backlight control unit 208 is electrically connected to the backlight driver 206 and to the backlight module 204. According to the open/close signals from the shutter glasses control unit 230, the backlight control unit 208 adjusts the backlight brightness of the backlight module 204. For example, when both of the left eye shutter 222 and the right eye shutter 224 of the shutter glasses 220 are closed, the backlight control unit 208 reduces the backlight brightness, and when the left eye shutter 222 and right eye shutter 224 are respectively opened, the backlight control unit 208 increases the backlight brightness.

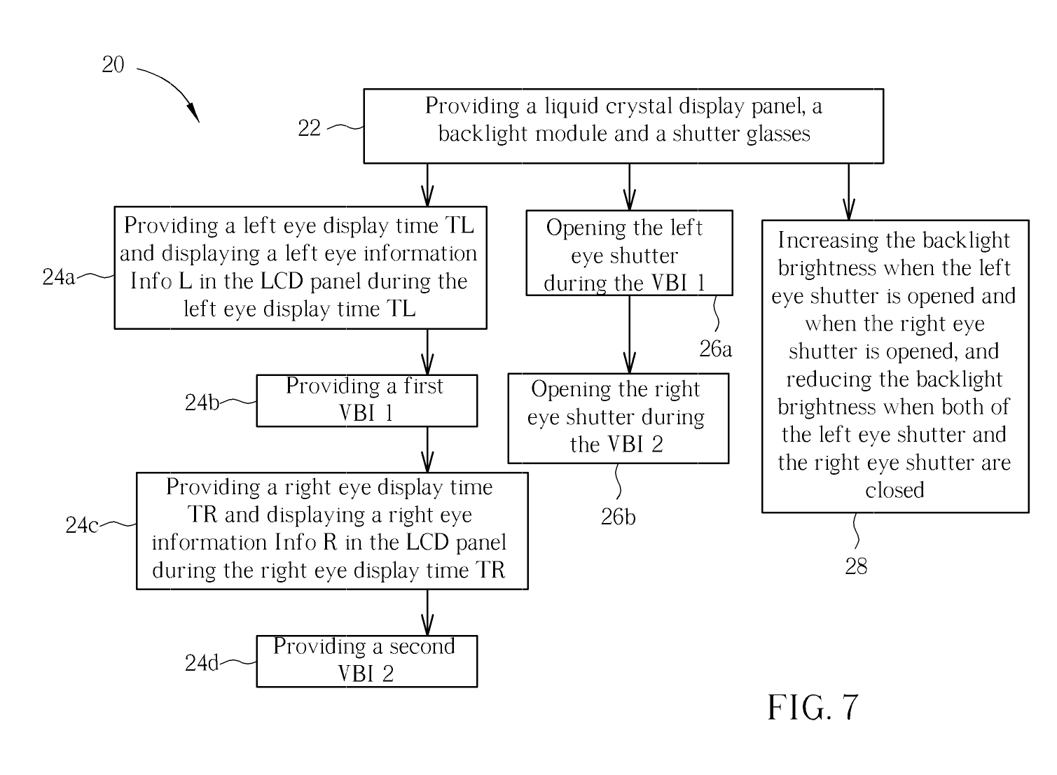

Please refer to FIGS. 7-8, which are schematic drawings illustrating a stereoscopic image displaying method provided by the second preferred embodiment, wherein FIG. 8 is a diagram of a time sequence in accordance with the second preferred embodiment. As shown in FIG. 7, in the stereoscopic image displaying method 20 provided by the second preferred embodiment, Step 22 is first performed:

Step 22: providing the LCD panel 202, the backlight module 204 and the shutter glasses 220;

As mentioned above, the shutter glasses 220 further includes a left eye shutter 222 and a right eye shutter 224. Furthermore, although only the LCD panel 202, the backlight module 204 and the shutter glasses 220 are mentioned in Step 22, it should be understood that the stereoscopic display device 200 of the second preferred embodiment still includes the backlight module drives 206, the backlight control unit 208, the panel information output unit 210, the shutter glasses control unit 230 and the 3D system control unit 240. Since the 3D images and differences of the brightness are perceived by viewing the LCD panel 202 and the backlight module 204 through the shutter glasses 220, only the LCD panel 202, the backlight module 204 and the shutter glasses 220 are emphasized in Step 22 of the stereoscopic image displaying method 20. However, those skilled in the art would easily realize the structural relationship between those elements based on the abovementioned description and drawing. Therefore those details are omitted in the interest of brevity. Then, Step 24a, Step 24b, Step 24c and Step 24d are sequentially and repeatedly performed:

Step 24a: providing a left eye display time TL and displaying a left eye information Info L in the LCD panel 202 during the left eye display time TL;

Step 24b: providing a first VBI 1;

Step 24c: providing a right eye display time TR and displaying a right eye information Info R in the LCD panel 202 during the right eye display time TR;

Step 24d: providing a second VBI 2;

Please refer to FIG. 8. When the image intended for being displayed is recognized as a 3D image, the 3D system control unit 240 inputs the left eye information Info L and the right eye information Info R to the panel information output unit 210, and the panel information output unit 210 subsequently provides the left eye information Info L and the right eye information Info R to the LCD panel 202. Then, The LCD panel 202 sequentially and alternately provides the left eye display time TL and the right eye display time TR for respectively displaying the left eye information Info L and the right eye information Info R by scanning. As mentioned above, the left eye information Info L scanned in the left eye display time TL is completely remained in the VBI 1 between the left eye display time TL and the right eye display time TR while the right eye information Info R scanned in the right eye display time TR is completely remained in the VBI 2 between the right eye display time TR and the left eye display time TL. The abovementioned process can be repeated until the observer turns off the stereoscopic display device 200 or ends the stereoscopic image displaying method 20. Simultaneously with performing Step 24a-Step 24d, Step 26a and Step 26b are performed:

Step 26a: opening the left eye shutter 222 during the VBI 1;

Step 26b: opening the right eye shutter 224 during the VBI 2;

As shown in FIG. 8, the 3D system control unit 240 simultaneously provides the left eye information Info L and the right eye information Info R to the shutter glasses control unit 230 according to the stereoscopic image displaying method 20 provided by the second preferred embodiment, and the shutter glasses control unit 230 provides open/close signals to the shutter glasses 220 in accordance with the left eye information Info L and the right eye information Info R: the left eye shutter 222 of the shutter glasses 220 is opened during a left eye shutter opening time tL that corresponding to the VBI 1 and the right eye shutter 224 is opened during a right eye shutter opening time tR that corresponding to the VBI 2. As mentioned above, since the complete left eye information Info L and the right eye information Info R are respectively remained in the VBI 1 and the VBI 2, the left eye shutter opening time tL and the right eye shutter opening time tR are respectively at least entirely cover the VBI 1 and the VBI 2 in the second preferred embodiment. Accordingly, a complete and non-interfered left eye image is obtained when the left eye shutter 222 is opened while a complete and non-interfered right eye image is obtained when the right eye shutter 224 is opened. More important, simultaneously with performing Step 24a-Step 24d and Step 26a-Step 26b, Step 28 is performed:

Step 28: increasing the backlight brightness when the left eye shutter 222 is opened and when the right eye shutter 224 is opened, and reducing the backlight brightness when both of the left eye shutter 222 and the right eye shutter 224 are closed.

Please still refer to FIG. 8. According to the stereoscopic image displaying method 20 provided by the second preferred embodiment, the shutter glasses control unit 230 simultaneously provides the open/close signals to the backlight control unit 208, and the backlight control unit 208 increases the backlight brightness of the backlight module 204 respectively during the left eye shutter opening time tL and the right eye shutter opening time tR, and reduces the backlight brightness of the backlight module 204 when both of the left eye shutter 222 and the right eye shutter 240 are closed. Furthermore, the “ON” designated in FIG. 8 states increasing the backlight brightness and the “OFF” states reducing the backlight brightness.

It is noteworthy that in the second preferred embodiment, the backlight brightness is increased respectively when the left eye shutter 222 is opened and when the right eye shutter 224 is opened, that is, the backlight brightness is increased respectively during the left eye shutter opening time tL and during the right eye shutter opening time tR, therefore the observer perceives improved 3d images. On the other hand, the left eye shutter 222 and the right eye shutter 224 are both closed in the left eye display time TL and the right eye display time TR, therefore no images are viewed by the observer. Accordingly, the performance quality are not be impacted by reducing the backlight brightness during the left eye display time TL and the right eye display time TR since the left eye shutter 222 and right eye shutter 224 of the shutter glasses 220 are both closed. In other words, by increasing the backlight brightness respectively during the left eye shutter opening time tL and the right eye shutter opening time tR, and reducing the backlight brightness during the left eye display time TL and the right eye display time TR, the power consumption is reduced while performance quality is not impacted.

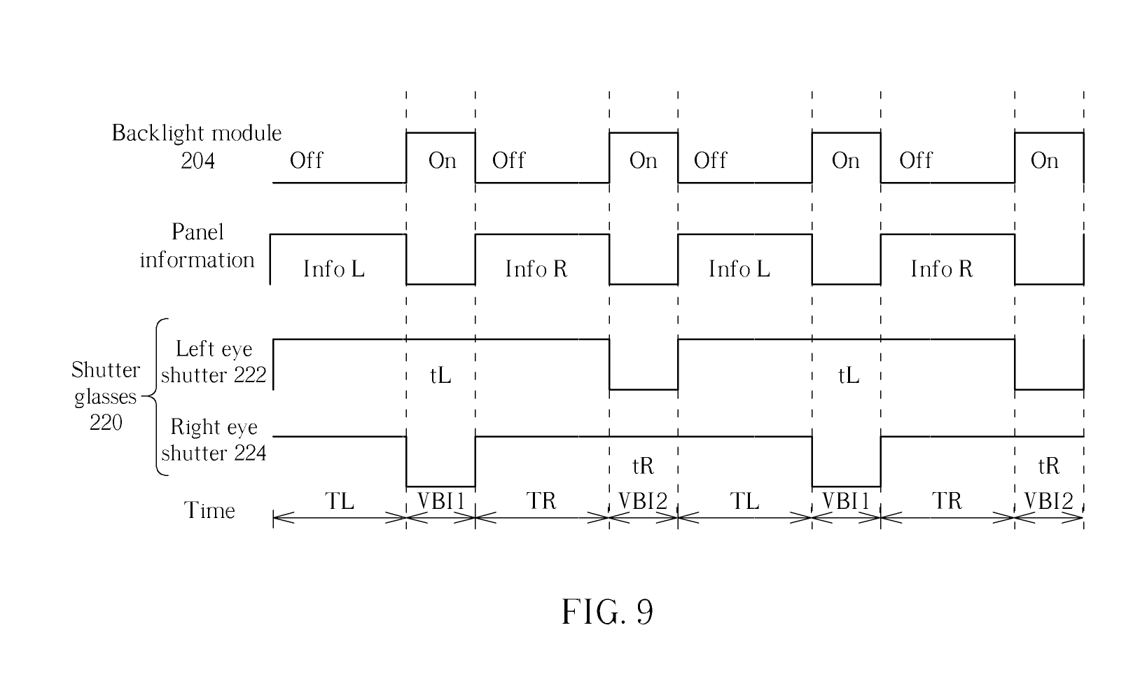

Please refer to FIG. 9, which is a diagram of a time sequence in accordance with a modification of the second preferred embodiment. As mentioned above, since the left eye shutter opening time tL and the right eye shutter opening time tR at least entirely cover the VBI 1 and VBI 2, respectively, the left eye shutter opening time tL and the right eye shutter opening time tR are shorter, and the periods of closing the left/right eye shutter are longer, compared to the lights viewed from a 2D display or viewed without the shutter glasses 220. Consequently, the observer perceives a perceptibly darker viewing field. To overcome this problem, the left eye shutter opening time tL and the right eye shutter opening time tR are corresponding to and longer than the VBI 1 and VBI 2, respectively as shown in FIG. 9: the left eye shutter opening time tL of the shutter glasses 220 starts simultaneously with the start of the left eye display time TL and ends simultaneously with the end of the right eye display time TR while the right eye shutter opening time tR starts simultaneously with the start of the right eye display time TR and ends simultaneously with the end of the left eye display time TL. Since the left eye shutter opening time tL and the right eye shutter opening time tR are prolonged, the environmental lights are allowed to enter the eyes of the observer and serve as the backlight source. Consequently, the differences of the backlight brightness will not be observed. Moreover, the observer will obtain a brighter viewing experience.

As mentioned above, according to the stereoscopic display device 200 and the stereoscopic image displaying method 20 provided by the second preferred embodiment, when the information intended for being displayed is recognized as a 3D image information, the shutter glasses control unit 230 is to control the backlight brightness of the backlight module 204 and the shutter glasses 220: the backlight brightness is increased respectively during the left eye shutter opening time tL and the right eye shutter opening time tR and is reduced when both of the left eye shutter 222 and the right eye shutter 224 are closed. Accordingly, the performance quality of the 3D image is improved and the power consumption is simultaneously economized.

According to the stereoscopic display device and a stereoscopic image displaying method provided by the present invention, a backlight brightness is increased during the VBI or when the left/right eye shutter is opened, and the backlight brightness is reduced when the left/right eye information is scanned or when the left/right eye shutter is closed. In other words, the switch between open-state and close-state of the shutter glasses and the brightness of the backlight module is correspondingly controlled by the provided stereoscopic display device. Consequently, the ghost image is prevented and the power consumption of the backlight module is economized.

Those skilled in the art will readily observe that numerous modifications and alterations of the device and method may be made while retaining the teachings of the invention.

What is claimed is:

1. A stereoscopic display device comprising:
a liquid crystal display panel for alternately providing a first display information, a second display information and a vertical blanking interval (VBI) between the first display information and the second display information;
a backlight module; and
a backlight control unit electrically connected to the backlight module for controlling a backlight brightness of the backlight module; wherein
the backlight control unit increases the backlight brightness of the backlight module during the VBI and reduces the backlight brightness of the backlight module respectively during the liquid crystal display panel providing the first display information or the second display information.

2. The stereoscopic display device of claim 1, further comprising a panel information output unit electrically connected to the liquid crystal display panel and the backlight control unit for providing the first display information and the second display information.

3. A stereoscopic display device comprising:
a liquid crystal display panel alternately providing a left eye information and a right eye information by scanning;
a backlight module;
a shutter glasses having a left eye shutter and a right eye shutter; and
a backlight control unit electrically connected to the backlight module for controlling a backlight brightness of the backlight module; wherein
the backlight control unit increases the backlight brightness of backlight module when the left eye shutter of the shutter glasses is opened or when the right eye shutter of the shutter glasses is opened.

4. The stereoscopic display device of claim 3, wherein the liquid crystal display panel further provides a first vertical blanking interval (VBI) between the left eye information and the right eye information, and a second VBI between the right eye information and the left eye information.

5. The stereoscopic display device of claim 4, wherein the left eye shutter of the shutter glasses is opened corresponding to the first VBI and the right eye shutter of the shutter glasses is opened corresponding to the second VBI.

6. The stereoscopic display device of claim 3, wherein the backlight control unit reduces the backlight brightness when both of the left eye shutter and the right eye shutter are closed.

7. The stereoscopic display device of claim 3, further comprising a panel information output unit electrically connected to the liquid crystal display panel.

8. The stereoscopic display device of claim 7, further comprising a shutter glasses control unit electrically connected to the backlight control unit for providing open/close signals to the backlight control unit and the shutter glasses.

9. The stereoscopic display device of claim 8, further comprising a 3D system control unit electrically connected to the panel information output unit and the shutter glasses control unit.

10. A stereoscopic image displaying method comprising:
providing a display panel and a backlight module;
providing a first display time and displaying a first display information during the first display time;
providing a second display time and displaying a second display information during the second display time;
providing a vertical blanking interval (VBI) between the first display time and the second display time; and
increasing a backlight brightness of the backlight module during the VBI and reducing the backlight brightness respectively during the first display time and during the second display time.

11. The stereoscopic image displaying method of claim 10, wherein the first display time and the second display time are provided alternately.

12. The stereoscopic image displaying method of claim 10, wherein a period of increasing the backlight brightness at least entirely covers the VBI.

13. The stereoscopic image displaying method of claim 10, further comprising:
providing a shutter glasses having a left eye shutter and a right eye shutter;
providing a left eye shutter opening time for opening the left eye shutter; and
providing a right eye shutter opening time for opening the right eye shutter.

14. The stereoscopic image displaying method of claim 13, wherein the left eye shutter opening time and the right eye shutter opening time at least entirely covers the VBI, respectively.

15. The stereoscopic image displaying method of claim 14, wherein the left eye shutter opening time and the right eye shutter opening time are longer than the VBI.

16. A stereoscopic image displaying method comprising:
providing a display panel, a backlight module and a shutter glasses, the shutter glasses having a left eye shutter and a right eye shutter;
providing a left eye display time and displaying a left eye information in the display panel during the left eye displaying time;
providing a first vertical blanking interval (VBI) and opening the left eye shutter of the shutter glasses;
providing a right eye display time and displaying a right eye information in the display panel during the right eye displaying time;
providing a second VBI and opening the right eye shutter of the shutter glasses; and
increasing a backlight brightness of the backlight module respectively when the left eye shutter is opened or when the right eye shutter is opened, and reducing the backlight brightness when both of the left eye shutter and the right eye shutter are closed.

17. The stereoscopic image displaying method of claim 16, wherein the left eye displaying time, the first VBI, the right eye display time and the second VBI are sequentially and repeatedly provided.

18. The stereoscopic image displaying method of claim 16, wherein a period of opening the left eye shutter at least entirely covers the first VBI and a period of opening the right eye shutter at least entirely covers the second VBI.

19. The stereoscopic image displaying method of claim 18, wherein the period of opening the left eye shutter is longer than the first VBI and the period of opening the right eye shutter is longer than the second VBI.

20. The stereoscopic image displaying method of claim 19, wherein the period of opening the left eye shutter sequentially covers the left eye displaying time, the first VBI and the right eye displaying time, and the period of opening the right eye shutter sequentially covers the right eye displaying time, the second VBI and the left eye displaying time.

21. A stereoscopic image displaying method comprising:
providing a first display time and a second display time alternately, and displaying a first display information and a second display information respectively during the first display time and the second display time;
providing a vertical blanking interval between the first display time and the second display time;
increasing a backlight brightness at least during the VBI and reducing the backlight brightness at least during a portion of the first display time and during a portion of the second display time; and
providing a left eye shutter opening time and a right eye shutter opening time alternately for respectively open a left eye shutter and a right eye shutter of a shutter glasses, the left eye shutter opening time and the right eye shutter opening time respectively being equal to or longer than a period of increasing the backlight brightness.

22. The stereoscopic image displaying method of claim 21, wherein the period of increasing the backlight brightness at least entirely covers the VBI.

23. The stereoscopic image displaying method of claim 21, wherein the left eye shutter opening time sequentially covers the first display time, the VBI and the second display time, and the right eye shutter opening time sequentially covers the second display time, the VBI and the first display time.
